(19) United States
(12) Patent Application Publication
(10) Pub. No.: US 2004/0016555 A1
(43) Pub. Date: Jan. 29, 2004

(54) Method for ploughing snow and a snow plough

(76) Inventor: Tapio Heikki Ortamala, Pirkkala (FI)

Correspondence Address: LARSON & TAYLOR, PLC, 1199 NORTH FAIRFAX STREET, SUITE 900, ALEXANDRIA, VA, 22314, US

(21) Appl. No.: 10/398,406

(22) PCT Filed: Oct. 5, 2001
(86) PCT No.: PCT/FI01/00862

(30) Foreign Application Priority Data
Oct. 5, 2000 (FI) 20002190

(51) Int. Cl. A01B 51/00

(52) U.S. Cl. 172/272

(57) ABSTRACT

A method of snow plough from a site using a snowplough with at least two plough blades (5) forming together a ploughing angle and there being on the ploughing site fixed objects, such as airport lamps (1), rising over the site surface. In the method, when the snow plough faces an object, the plough front end is opened and the area, with the object on it, left un-ploughed by the open front end, is cleaned by means of brushes (6, 7) in the rear of the plough front end.

The invention relates to a method of snow ploughing from a site using a snowplough furnished with at least two blades forming together a required ploughing angle and there being on the ploughing site fixed objects, such as airport lamps, rising over the site surface and smallish elevations or similar.

Previously known is an airport snowplough having two blades in a required angle to form a plough The blades are apart from one another so that a distance of 0.5-1 meters remains between their front ends. On front side of the plough at the pointed front end brushing devices are installed to brush forward or to the sides the lane that remains unploughed between the front ends of the plough blades. Since there is on the air port site lamps rising over the its surface, ploughing is carried out so that the ploughing equipment is driven over the lamps from the middle, whereby the brushes hit the lamps cleaning and the unploughed lane.

The disadvantage of the above arrangement is that the brushes wear out strongly on working continuously against a rough surface. The plough is not fit for use in deep snow, since the brushes cannot move a thick layer of snow in front of the blades. The plough is suited only for snow ploughing, since the brush portion cannot remove ice nor any other harder material from the surface.

The aim of the invention is to produce a better ploughing result both on ploughing a plain site and an obstacle, as ploughing over a light fitting. This is achieved by means of the new ploughing method and snow plough. The invention is characterized in what is presented in the claims.

The advantage of the ploughing method and the snow plough as per the invention is that on a site without obstacles snow ploughing is carried out completely by means of the plough blades, whereby the track of ploughing is even. The capacity of moving even a thick layer of snow is appreciably better than that of brush snow ploughs. On a site with no obstacles it is possible to plough at a higher speed and to decelerate at light fixtures. Only facing an obstacle the front end of the plough is opened momentarily and cleaning is carried out by brushes. The brushes are longlasting thanks to the minor use. Opening the front end of plough does no change the working width of the plough and the plough can be used as a normal plough with the front end closed, when the brushes are retracted.

In the following the invention is disclosed with reference to the enclosed drawing, where

FIG. 1 shows the plough from above with the front end closed.

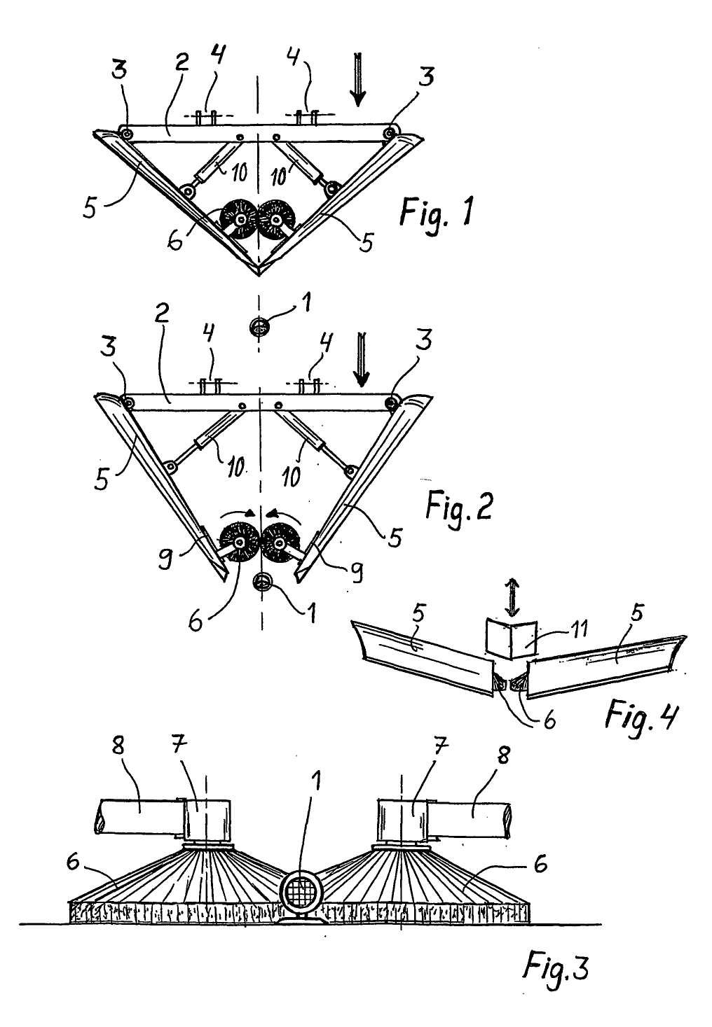

FIG. 2. shows the plough from above with the front end open.

FIG. 3 shows the brush end from one side.

FIG. 4 shows the plough with a pointed piece that can be lifted.

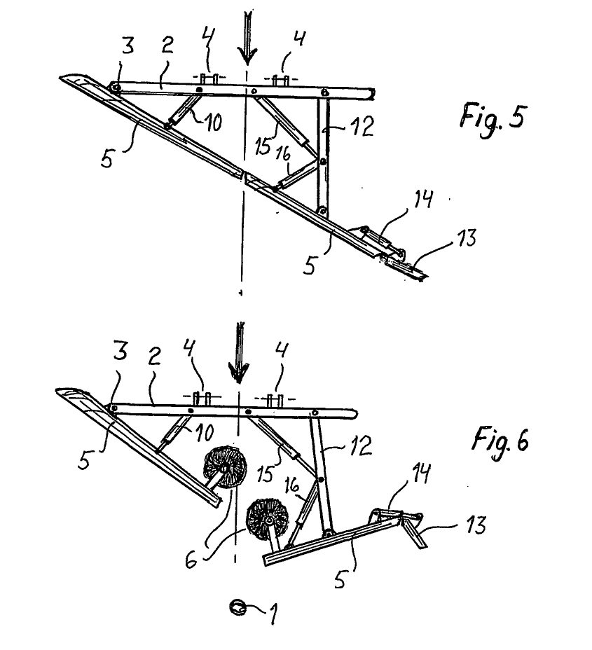

FIG. 5 shows a plough where the blades are parallel.

FIG. 6 shows the plough with open blades.

FIG. 1 is a plough furnished with two blades 5, the blades 5 of which are by an articulated joint 3 fixed to the plough body 2. By means of cylinders 10 the pointed front end of the plough can be opened and closed. The plough is fixed to the working machine by means of fixing components 4 in plough body 2. The plough has brushes 6 attached to the rear end surface of blades 5. Alternatively, brushes 6 can be firmly fixed to body 2 and rotated only when the plough front end is open.

FIG. 2 is the plough with its front end open, whereby the blades 5 are slightly turned by cylinders 10. Rotatable brushes 6 are moved slightly forward along guides 9 on the rear surface of the blades. The guides 9 are, advantageously, slanting a little, whereby the brushes get lower on moving towards the front ends of blades 5 and reaching the brushing position. FIG. 2 shows how a lamp 1 on the field is run over by opening the plough front end and rotating the brushes on the lamp. Immediately after the lamp 1 the plough front end is closed and brushes driven upward and backward. Body 2 is high enough and the working machine has sufficient ground clearance so that it is possible to drive over the lamp. The height of airport lamps is max. 500 mm. In FIG. 3 the brush equipment is shown with lamp 1 in front of it. Brushes 6 are by means of arms 8 attached to the back of blades 5. In the top of arms 8 there is a hydraulic motor 7 rotating the brushes. The brushes can have different shapes according to size and shape of lamps or other obstacles on the site.

By means of brushes 6 the aim is, in a situation as per FIG. 2, to throw the snow faced by brushes through the front end opening in large quantities to the plough front side, whereby the snow gets, finally, moved by means of blades 5 to the sides. There are 2 brushes 6 so that there is space for a lamp between the brushes, when the plough runs over the lamp.

In FIG. 4 an alternative solution is shown in order to open and close the plough front end by means of an pointed piece 11 that can be lifted up. In this construction the brushes 6 can stay in place. They can be lifted from the ground when not rotated, i.e. when the pointed piece 11 is let down.

It is also possible to use other ways of opening the front end, such as the pointed piece in FIG. 4, which is halved into two parts so that one part is moved sideways in front of one blade and the other correspondingly in front of the plough, whereby the plough front end is open as shown in FIG. 4. The brushes are not illustrated in this figure. Yet they are included in the equipment

FIG. 5 is a plough, where blades 5 are parallel in working position. For one blade there is an auxiliary arm 12, which can be turned by means of cylinder 15. Blade 5 is turned by means of cylinder 16. There is as blade extension an extra blade 13 turned by means of cylinder 14. The brushes are not illustrated in this figure. Yet they are included in the apparatus as shown in FIG. 6.

In FIG. 6 an example of an embodiment is presented showing how the blades are opened on hitting an obstacle. Auxiliary arm 12 is turned slightly outward. The blade 5 resting on it is also turned for ploughing a little outward, whereby snow drifts against the extra blade 13 turned forward for the time the lamp is passed by and the blades 5 are again in the position of FIG. 5. By means of brushes 6 the place, where lamp 1 is, gets cleaned on passing. Extra blade 13 prevents snow from drifting to the “wrong” side of the route.

A plough according to FIGS. 1-4 is advantageous to use also by another kinds of ploughing, since it works with its front end closed as a common plough.

1. A method for ploughing snow from a site using a snowplough with at least two plough blades (5) forming together a required ploughing angle and there being on the ploughing site fixed objects, such as airport lamps (1), rising over the site surface, characterized in that when the snow plough faces an object (1) the space between plough blades (5) is opened and the area and the object (1) on it, which remain unploughed, get cleaned by means of brush equipment (6,7) in the rear end of blades (5).

2. A method according to claim 1 characterized in that the space between plough blades is opened by turning blades (5) about fixed joint point (3).

3. A method according to claim 1 characterized in that the space between plough blades is opened by lifting up pointed piece 11).

4. A method according to claim 1 characterized in that the space between plough blades is opened by moving the blades-connecting parts in the direction of the blades.

5. A method according to any of the above claims 1-4 characterized in that the brushes (6,7) are switched on and kept working only when the plough front end is in opened position.

6. A method according to any of the above claims 1-5 characterized in that by means of a turnable extra blade (13) in blade (5) drifting of snow on the not-wanted side of plough is prevented.

7. A snowplough, attached to a working machine by means of fixing components (4) in plough body (2), and furnished at least with two plough blades (5) forming together a required ploughing angle, characterized in that, as to the portion between them, the plough blades (5) are arranged to get opened mutually in order to produce an unploughed lane in the space between the blades, whereby brushing equipment (6,7) is arranged in the rear end of blades (5) so that by means of brushes the area with objects (1) on it, which has been left unploughed by the space between the blades, can be brushed clean.

8. A method according to claim 7 characterized in that blades (5) are from their rear end attached to body (2) by means of fixed joint points (3) in order to open the space between blades (5) by turning them about the fixed joint points by means of a power unit (10).

9. A method according to claim 7 characterized in that there is between the blades a piece (11) that can be lifted up in order to open the space between the blades.

10. A method according to claim 7 characterized in that there are between blades (5) blade parts movable in the direction of the blades in order to open the space between blades.
